(19) United States
(12) Patent Application Publication
(10) Pub. No.: US 2024/0305741 A1
(43) Pub. Date: Sep. 12, 2024

(54) APPARATUS, SYSTEMS, AND METHODS FOR PROVIDING AND ANALYZING ON-VIDEO CONTENT DURING PRESENTATIONS

(71) Applicant: VODIUM, LLC, Nashville, TN (US)

(72) Inventors: MARY MELLOR, Nashville, TN (US); Camille Padilla, Chicago, IL (US)

(21) Appl. No.: 18/661,314

(22) Filed: May 10, 2024

Related U.S. Application Data
(63) Continuation-in-part of application No. 18/572,585, filed on Dec. 20, 2023.
(60) Provisional application No. 63/215,080, filed on Jun. 25, 2021.

(51) Int. Cl. H04N 5/272; G06F 3/0481; G06F 3/04845; G06T 7/00; G06T 7/70

(52) U.S. Cl. CPC H04N 5/272; G06F 3/0481; G06F 3/04845; G06T 7/0002; G06T 7/70; G06T 2207/30196

(57) ABSTRACT

Systems and methods as disclosed herein provide on-video content during a video presentation by a user. An electronic device can include or be linked to a display unit and a capture element having a field of view including the user. During execution of one or more applications (e.g., including a web conferencing platform), the device generates in a screen area of the display a first image layer comprising content associated with the presentation, and generates in the screen area a second image layer comprising an at least partially transparent content window, wherein the second image layer at least partially overlaps the first image layer. Content displayed in the content window is provided according to the presentation and can for example include notes for the user. A generated location of the content window within the screen area is dependent at least in part on a determined location of the capture element.

### CROSS-REFERENCE TO RELATED APPLICATIONS

This application is a continuation-in-part of U.S. application Ser. No. 18/572,585, filed Dec. 20, 2023, which was a § 371 national stage entry of PCT/US2022/034795 filed Jun. 23, 2022, which claims priority to U.S. Provisional Patent Application No. 63/215,080 entitled “APPARATUSES, SYSTEMS, AND METHODS FOR PROVIDING ON-VIDEO CONTENT,” filed Jun. 25, 2021, all of which are hereby incorporated by reference in their entireties.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights.

### GOVERNMENT INTERESTS

Not applicable.

### TECHNOLOGICAL FIELD

The present disclosure relates generally to systems and methods for providing on-video content. More particularly, an embodiment of an invention as disclosed herein relates to providing on-video content to a presenter, in a manner that can be spatially optimized to provide the appearance of eye contact without altering or otherwise compromising the underlying conferencing platform or equivalent thereof.

### BACKGROUND

This section is intended to introduce various aspects of the art, which can be associated with exemplary embodiments of the present disclosure. This discussion is believed to assist in providing a framework to facilitate a better understanding of aspects of the present disclosure. Accordingly, it should be understood that this section should be read in this light, and not necessarily as admissions of prior art.

Numerous problems exist in the art in relation to effective communication, particularly in the field of technology-assisted communication. The COVID-19 pandemic and shift to virtual work has radically changed communication. Despite a majority of work being performed remotely during the pandemic, conventional tools are still unable to sufficiently transform the way people work, and in how they maintain their presence while presenting and communicating virtually, without putting even the most skilled communicators at a disadvantage. It has been estimated that communication is 93% nonverbal, much of which is lost or simply ineffective using existing videoconference systems. There is a weakened rate of social presence over video conference, wherein for example people perceive a lower quality impact of eye contact over video conference and give lower performance ratings over video conference. This means many of the best presenters are already behind. Furthermore, eye contact is critical to communication-increasing trust according to some sources by 16%—but it does not come naturally when presenting virtually. Because people decide whether they find a particular subject interesting or not within the first eight seconds, lost nonverbal communication ability can hinder listener interest. It is hard to convey tone without body language, still harder to maintain eye contact, and almost impossible to immediately capture and retain your audience's attention.

### SUMMARY OF THE INVENTION

Disclosed herein are apparatuses, systems, and methods for providing on-video content, for example for use during web conferences or videoconferences.

In one aspect, the present disclosure relates to a method for providing on-video content during a video presentation by at least one user. In embodiments, the method comprises, during execution of one or more applications by an electronic device associated with at least a display unit and a capture element having a field of view including the at least one user: generating in a screen area of the display unit a first image layer comprising content associated with at least one of the one or more applications; and generating in the screen arca of the display unit a second image layer comprising a content window, wherein content displayed in the content window is provided in accordance with the at least one of the one or more applications. In embodiments, a generated location of the content window within the screen area can be arranged at a user-preferred position. The user-preferred position can be dependent at least in part on a determined location of the capture element. In embodiments, the user-preferred position is disposed within a side window of the one or more applications, such that the content window is accessible within an environment of the one or more applications. In certain embodiments, the user-preferred position is least partially overlapping the first image layer. In embodiments, the one or more applications comprise Microsoft Teams® (Microsoft Corporation, Cincinnati, OH).

Embodiments of the presently disclosed method can further comprise revising the content according to a user-preferred parameter, wherein the user-preferred parameter comprises a time limit for the video presentation. In embodiments, automatically revising the content comprises any one or more of: automatically adding additional content to satisfy the time limit, automatically increasing a scrolling speed of the content on the display unit to satisfy the time limit, removing content to satisfy the time limit, decreasing the scrolling speed of the content to satisfy the time limit, or a combination thereof.

The method can further comprise automatically ascertaining a location of the at least one user relative to the capture element. In certain embodiments, the method comprises automatically detecting a performance metric of the user via the capture element, analyzing the performance metric of the user, and automatically providing feedback to the user.

The performance metric can comprise any one or more of a use or frequency of filler words, the user's tone or confidence, a speed or pace of the presentation, the user's adherence to the content, and an amount of user eye contact with the capture element.

Certain embodiments of the presently disclosed method further comprise providing an audience member with one or more applications for viewing the video presentation on an audience member electronic device that is associated with a second display unit; generating in a screen area of the second display unit a content-viewing window; wherein the video presentation is provided in the content-viewing window in accordance with the at least one of the one or more applications; generating and displaying a feedback input portion of the content-viewing window; accepting a feedback input from the audience member; automatically transmitting the feedback input to the electronic device; and displaying the feedback input to the user via the content window. The method can also comprise an audience member capture element having a field of view including the audience member; capturing an audience sentiment metric from the audience member via the capture element; automatically analyzing the audience sentiment metric; automatically generating a performance score, wherein the performance score is dependent on the audience sentiment metric; and displaying the performance score to the user via the content window.

The audience sentiment metric can comprise the amount of time the audience member's eyes are directed toward the content-viewing window, a number of questions asked verbally by the audience member, a number of questions asked in a chat feature of the one or more applications, a time the audience member spends in front of the capture element, a number of times the audience member looks away from the content-viewing window, the total amount of time the audience member spends looking away from the content-viewing window during the video presentation, audience participation in polls, audience time spent speaking as compared to the speaker time spent speaking, or a combination thereof.

In embodiments, the content is displayed in the content window according to one or more parameters set via user input from the at least one user.

Another aspect of the presently disclosure relates to a system for providing on-video content during a video presentation by at least one user. In various embodiments, the system comprises: an electronic device comprising a processor functionally linked to at least a display unit and a capture element having a field of view including the at least one user, wherein the processor is configured, during execution of one or more applications via the electronic device, to: generate in a screen area of the display unit a first image layer comprising content associated with at least one of the one or more applications; generate in the screen area of the display unit a second image layer comprising a content window; and wherein a generated location of the content window within the screen area is arranged at a user-preferred position. In embodiments, the user-preferred position is dependent at least in part on a determined location of the capture element. The user-preferred position can be disposed within a side window of the one or more applications, such that the content window is accessible within an environment of the one or more applications. The user-preferred position can be at least partially overlapping the first image layer. In one embodiment, the at least one of the one or more applications comprises a web conferencing platform. The web conferencing platform can be Microsoft Teams R (Microsoft Corporation, Cincinnati, OH)

In embodiments, the processor is further configured to automatically revise the content according to a user-preferred parameter, wherein the user-preferred parameter comprises a time limit for the video presentation. Automatically revising the content can comprise any one or more of: automatically adding additional content to satisfy the time limit, automatically increasing a scrolling speed of the content on the display unit to satisfy the time limit, removing content to satisfy the time limit, decreasing the scrolling speed of the content to satisfy the time limit, or a combination thereof. In embodiments, the processor is further configured to automatically ascertain a location of the at least one user relative to the capture element. The processor can be configured to automatically detect a performance metric of the user via the capture element, analyzing the performance metric of the user, and automatically providing feedback to the user. In embodiments, the performance metric comprises any one or more of a use or frequency of filler words, the user's tone or confidence, a speed or pace of the presentation, the user's adherence to the content, and an amount of user eye contact with the capture element.

In certain embodiments, the system comprises an audience member electronic device comprising a second processor functionally linked to a second display unit and a second capture element having a field of view including at least one audience member. The second processor can be configured, during execution of one or more applications via the audience member electronic device, to generate in a screen area of the second display unit a content-viewing window associated with at least one of the one or more applications. In certain embodiments, the content-viewing window is configured to display the video presentation to the at least one audience member; generate and display a feedback input portion of the content-viewing window; accept a feedback input from the at least one audience member; automatically transmit the feedback input to the electronic device, or a combination thereof. In embodiments, the processor on the electronic device is configured to display the feedback input to the user via the content window. The system can further comprise an audience member capture element having a field of view including the audience member. In certain embodiments, the audience member capture element is configured to capture an audience sentiment metric from the audience member. The second processor can be configured to transmit the audience sentiment metric to the electronic device. The processor can be configured to receive the audience sentiment metric; analyze the audience sentiment metric; generate a performance score, wherein the performance score is dependent on the audience sentiment metric; display the performance score to the user via the content window; or any combination thereof.

In certain embodiments, the audience sentiment metric comprises the amount of time the audience member's eyes are directed toward the content-viewing window, a number of questions asked verbally by the audience member, a number of questions asked in a chat feature of the one or more applications, a time the audience member spends in front of the capture element, a number of times the audience member looks away from the content-viewing window, the total amount of time the audience member spends looking away from the content-viewing window during the video presentation, or a combination thereof.

Other objects and advantages of this invention will become readily apparent from the ensuing description.

### BRIEF DESCRIPTION OF THE FIGURES

Certain illustrations, charts, or flow charts are provided to allow for a better understanding for the present invention. It is to be noted, however, that the drawings illustrate only selected embodiments of the inventions and are therefore not to be considered limiting of scope. Additional and equally effective embodiments and applications of the present invention exist.

FIG. 1 illustrates an exemplary embodiment of a partial block network diagram according to aspects of the present disclosure.

FIG. 2 illustrates a partial block diagram of an on-video configuration according to aspects of the present disclosure.

FIG. 3 illustrates an alternative partial block diagram of an on-video configuration according to aspects of the present disclosure.

FIG. 4 illustrates an exemplary embodiment of a content window according to aspects of the present disclosure.

FIG. 5 illustrates an exemplary embodiment of a content window including content according to aspects of the present disclosure.

FIG. 6 illustrates an exemplary embodiment of a settings window according to aspects of the present disclosure.

FIG. 7 illustrates an exemplary embodiment of the content window of FIG. 6 for an activated license according to aspects of the present disclosure.

FIG. 8 illustrates an exemplary embodiment of an activation screen during a trial period according to aspects of the present disclosure.

FIG. 9 illustrates an exemplary embodiment of an activation screen after expiration of a trial period according to aspects of the present disclosure.

FIG. 10 illustrates an exemplary embodiment of a subscription verification window according to aspects of the present disclosure.

FIG. 11 illustrates an exemplary embodiment of a content window according to aspects of the present disclosure.

FIG. 12 illustrates an exemplary embodiment of a content window according to another aspect of the present disclosure, wherein the content window is shown operating within the environment of a videoconferencing application.

FIG. 13 illustrates an exemplary embodiment of the content window of FIG. 6 according to additional aspects of the present disclosure.

FIG. 14 shows a schematic view of a system under another embodiment of the present disclosure, wherein the system is configured to operate within the environment a videoconferencing application.

### DETAILED DESCRIPTION OF THE INVENTION

Detailed descriptions of one or more embodiments are provided herein. It is to be understood, however, that the present invention can be embodied in various forms. Therefore, specific details disclosed herein are not to be interpreted as limiting, but rather as a basis for the claims and as a representative basis for teaching one skilled in the art to employ the present invention in any appropriate manner.

The singular forms “a,” “an,” and “the” include plural reference unless the context clearly dictates otherwise. The use of the word “a” or “an” when used in conjunction with the term “comprising” in the claims and/or the specification can mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited. Therefore, for example, the phrase “wherein the lever extends vertically” means “wherein the lever extends substantially vertically” so long as a precise vertical arrangement is not necessary for the lever to perform its function.

The terms “comprising” and “including” and “having” and “involving” (and similarly “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b, and c. Wherever the terms “a” or “an” are used, “one or more” is understood, unless such interpretation is nonsensical in context.

As used herein the term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

For purposes of the present disclosure, it is noted that spatially relative terms, such as “up,” “down,” “right,” “left,” “beneath,” “below,” “lower,” “above,” “upper” and the like, can be used herein for case of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device can be otherwise oriented (rotated 90 degrees or at other orientations) and the spatially relative descriptors used herein interpreted accordingly.

As used herein, the phrase “filler words” can refer to words or sounds that a user produces during a presentation to fill pauses, indicate hesitation, give themselves time to think, or a combination thereof. Non-limiting examples of filler words in the English language include: “um,” “uh,” “well,” “like,” “you know,” “so,” “basically,” “actually,” “literally,” “I mean,” “sort of,” “kind of,” “okay,” “anyway,” “right,” and the like.

### DESCRIPTION OF SELECTED EMBODIMENTS

Before explaining at least one embodiment of the disclosure in detail, it is to be understood that the disclosure is not necessarily limited in its application to the details set forth in the following description or exemplified by the examples. The disclosure is capable of other embodiments or of being practiced or carried out in numerous ways. Other compositions, compounds, methods, features, and advantages of the present disclosure will be or become apparent to one having ordinary skill in the art upon examination of the following drawings, detailed description, and examples. It is intended that all such additional compositions, compounds, methods, features, and advantages be included within this description, and be within the scope of the present disclosure.

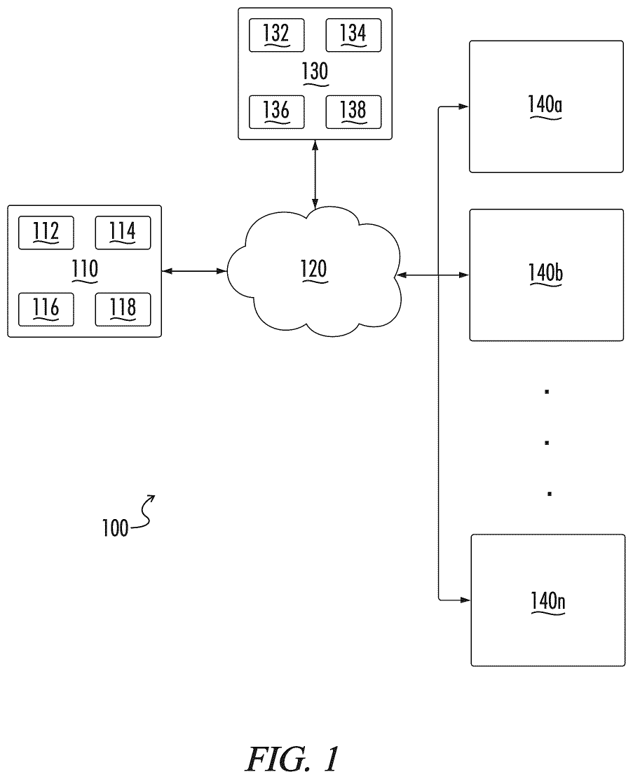

Referring generally to FIGS. 1-13, various exemplary apparatuses, systems, and associated methods according to the present disclosure are described in detail. Where the various figures can describe embodiments sharing various common elements and features with other embodiments, similar elements and features are given the same reference numerals and redundant description thereof can be omitted below.

Various embodiments of an apparatus according to the present disclosure can provide apparatuses, systems, and methods for providing on-video content, for example for use during web conferences or videoconferences.

FIG. 1 illustrates an exemplary embodiment of a partial block network diagram according to aspects of the present disclosure. The system 100 is a simplified partial network block diagram reflecting a functional computing configuration implementable according to aspects of the present disclosure. The system 100 includes a user device 110 coupleable to a network 120, a server 130 coupleable to the network 120, and one or more electronic devices 140a, 140b, . . . , 140n coupleable to the network 120. The server 130 can be a standalone device or in combination with at least one other external component either local or remotely communicatively coupleable with the server 130 (e.g., via the network 120). The server 130 can be configured to store, access, or provide at least a portion of information usable to permit one or more operations described herein. For example, the server 130 can be configured to provide a portal, webpage, interface, and/or downloadable application to a user device 110 to enable one or more operations described herein. The server 130 can additionally or alternatively be configured to store content data and/or metadata to enable one or more operations described herein.

In one exemplary embodiment, the network 120 includes the Internet, a public network, a private network, or any other communications medium capable of conveying electronic communications. Connection between elements or components (also referred to herein as “communicative coupling”) of FIG. 1 can be configured to be performed by wired interface, wireless interface, or combination thereof, without departing from the spirit and the scope of the present disclosure. At least one of the user device 110 and/or the server 130 can include a communication unit 118, 138 configured to permit communications for example via the network 120. Communications between the communication unit 118, 138 and any other component can be encrypted in various embodiments.

In one exemplary operation, at least one of user device 110 and/or server 130 is configured to store one or more sets of instructions in a volatile and/or non-volatile storage 114, 134. The one or more sets of instructions can be configured to be executed by a microprocessor 112, 132 to perform operations corresponding to the one or more sets of instructions.

In various exemplary embodiments, at least one of the user device 110 and/or server 130 is implemented as at least one of a desktop computer, a server computer, a laptop computer, a smart phone, or any other electronic device capable of executing instructions. The microprocessor 112, 132 can be a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result. Although described as a microprocessor, it should be appreciated that the microprocessor 112, 132 can be any type of hardware and/or software processor or component and is not strictly limited to a microprocessor or to any operation(s) only capable of execution by a microprocessor.

One or more computing component and/or functional element can be configured to operate remotely and can be further configured to obtain or otherwise operate upon one or more instructions stored physically remote from one or more user device 110, server 130, and/or functional element (e.g., via client-server communications or cloud-based computing).

At least one of the user device 110 and/or server 130 can include a display unit 116, 136. The display unit 116, 136 can be embodied within the computing component or functional element in one embodiment and can be configured to be either wired to or wirelessly interfaced with at least one other computing component or functional element. The display unit 116, 136 can be configured to operate, at least in part, based upon one or more operations of the described herein, as executed by the microprocessor 112, 132.

The one or more electronic devices 140a, 140b, . . . , 140n can be one or more devices configured to store data, operate upon data, and/or perform at least one action described herein. One or more electronic devices 140a, 140b, . . . , 140n can be configured in a distributed manner, such as a distributed computing system, cloud computing system, or the like. At least one electronic device 140 can be configured to perform one or more operations associated with or in conjunction with at least one element described herein. Additionally or alternatively, one or more electronic device 140 can be structurally and/or functionally equivalent to the server 1:30.

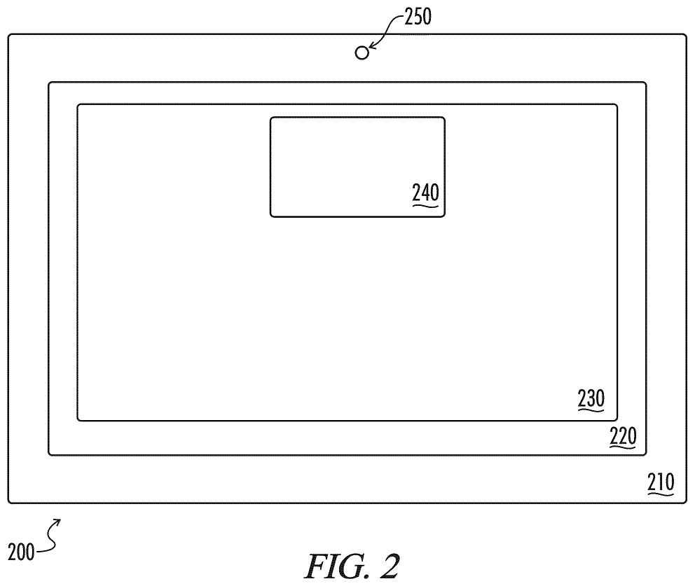

FIG. 2 illustrates a partial block diagram of an on-video configuration according to aspects of the present disclosure. A system 200 can include a display unit 210, for example as previously described with reference to the display unit 116, 136 of the user device 110 and/or server 130. The display unit 210 can include or refer to any type of display device, including but not limited to a television, a smart television, a Liquid Crystal Display (LCD) monitor or screen, a Light-Emitting Diode (LED) monitor or screen, a Cathode-Ray Tube (CRT) monitor or screen, a plasma monitor or screen. a projector, a dynamic billboard or advertising display, a laptop computer or screen, a tablet device or screen, a desktop computer or screen/monitor, a phone display, a smartphone display, or the like, either alone or in combination.

The display unit 210 can include a screen area 220. One or more applications 230 can be visually presented via at least a portion of the screen area 220. The one or more applications 230 can include a web browser, portal, and/or standalone application in various embodiments. The one or more applications 230 can be a video or videoconferencing application, webpage, portal, or the like, which is viewable via the display unit 210. The one or more applications 230 can include, for example but not limited to, a web conference or videoconferencing software. Non-limiting, exemplary web conference or videoconferencing software includes Zoom, Connectv Vise Control, BlueJeans Meetings, Microsoft Teams® (Microsoft Corporation, Cincinnati, OH), Google Hangouts Meet, or any other audio, video, or other form of conferencing or communications-capable software or module. At least one content window 240 can be provided consistent with the present disclosure. The content window 240 can be implemented as a standalone app, as a webpage, a portal, a client software, a thin client, or any other software or communicatively accessible form capable of performing as described herein. In alternate embodiments, the content window 240 is integrated within or otherwise accessible through a videoconferencing or web conference application 230. A content window 240 can include at least a portion of content that is visually presented to a user, for example, as an overlay to the one or more applications 230. The content window 240 can be formatted to operate within or incorporated directly into one or more applications 230. The content window 240 can be configured to visually convey at least a portion of content to a user of the display unit 210. The at least a portion of content can include information relating to or otherwise in association with the one or more application 230. For example, where the application 230 is a videoconferencing application, the content window 240 can visually text to the user. In embodiments, the content window is configured to convey at least one of scripted text or notes corresponding to a presentation to be presented or a discussion via the videoconferencing application. In addition, the content displayed via the content window 240 can comprise additional or other content, such as discussion notes or other information helpful in preparation for, during participation in, or for use after a session of the videoconferencing application.

At least one capture element 250 can be associated with the system 200 and can be configured to capture at least one of audio and/or video information. In various embodiments the capture element can be a camera unit, either with or without an audio capture element such as a microphone to capture audio. The at least one capture element 250 can be a webcam in an exemplary embodiment and can be configured as part of a user device 110, such as a built-in camera and/or microphone on a laptop computer, tablet, smartphone, or other electronic device. The at least one capture element 250 can be configured to capture audiovisual information for use by an application 230, such as a videoconference application. Captured audiovisual information from the at least one capture element 250 can further be used for example to identify or otherwise ascertain a location of a user (e.g., the presenter), as for example within a field of view of images captured by the at least one capture element 250.

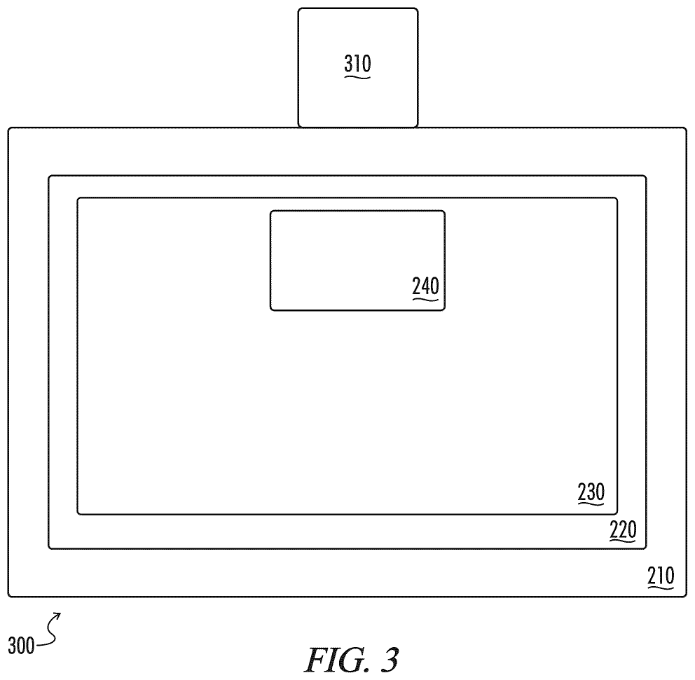

FIG. 3 illustrates an alternative partial block diagram of an on-video configuration according to aspects of the present disclosure. The system 300 includes the display unit 210 of FIG. 2, but with a capture element 310 which can be separated from the display unit 210. The capture element 310 can be functionally equivalent to the at least one capture element 250 and can optionally be used in conjunction with the at least one capture element 250 of FIG. 2. The capture element 310 can be physically and/or communicatively coupleable to a user device 110, for example at a display unit 210 thereof. The capture element 310 can be an external webcam, which can be physically remote from the display unit 210 without departing from the spirit and scope of the present disclosure.

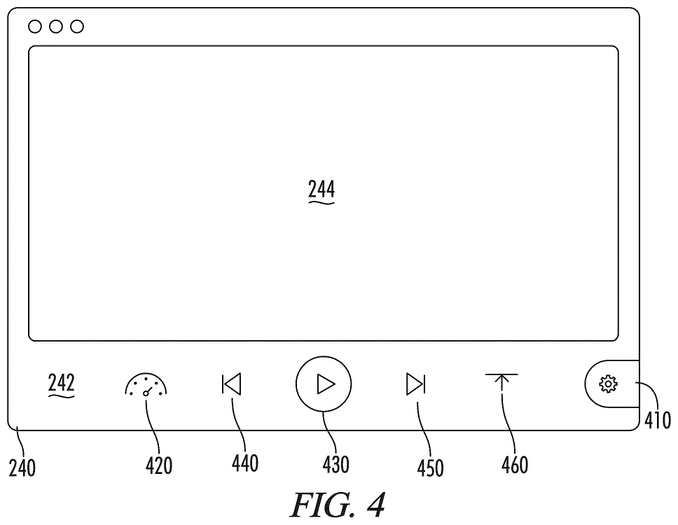

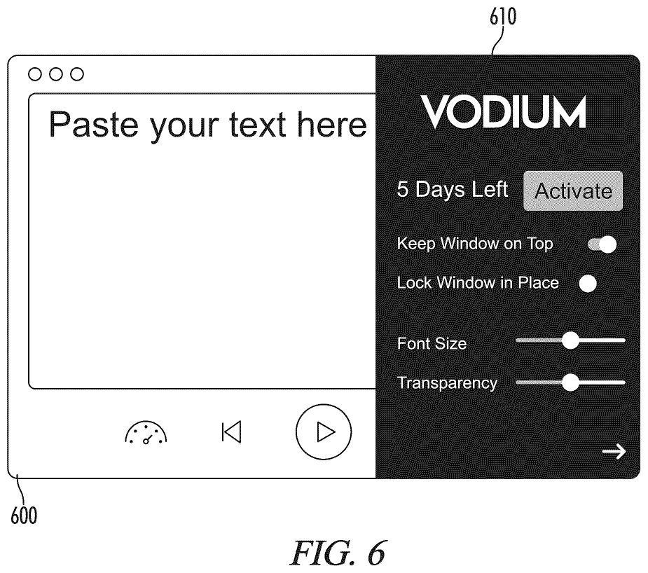

FIG. 4 illustrates an exemplary embodiment of a content window according to aspects of the present disclosure. The content window 240 can include a body 242 and a content section 244. The body 242 can include one or more of a settings section 410, a timing section 420, a play section 430, a reverse section 440, a forward section 450, and/or a return to top section 460. The settings section 410 can be selectable by a user to permit a user to selectively adjust one or more settings associated with the content window 240, for example as illustrated and described herein with reference to FIGS. 6-13. Selection of the timing section 420 can permit a user of the content window 240 to set or adjust a scrolling speed of information within the content section 244. This can be done, for example, using a scroll speed slider or other means of setting or adjusting a scrolling speed within the content section 244. The timing section 420 can be configured in various embodiments to adjust content scrolling within the content section 244 such as to meet a predetermined time period.

The play section 430 can be selected by a user to begin or to pause scrolling or presentation of content within the content section 244. The speed of scrolling within the content section can be adjusted, for example, as previously described with reference to the timing section 420. The reverse section 440 can be used to selectively move between portions of content to be included within the content section 244. This can include, for example, performing a page up operation to show previous content within the content section 244, performing a manual reverse scroll operation, selecting a separate set of content to be presented, for example corresponding to a current or previous slide presented by the user using the application 230, can include reverse scrolling through the content in the content section 244, moving to a previous chapter or set point within the content, or the like. Additionally or alternatively, the reverse section 440 can be used to reverse scroll or move through at least a portion of content presented in the content section 244. The forward section 450 can be used to selectively move between portions of content to be included within the content section 244. This can include, for example, performing a page down operation to show a next set of content within the content section 244, performing a manual scroll forward operation, selecting a separate set of content to be presented, for example corresponding to a current or next slide presented by the user using the application 230, can include scrolling through the content in the content section 244, moving to a next chapter or set point within the content, or the like. Additionally or alternatively, the forward section 450 can be used to move forward through at least a portion of content presented in the content section 244. The return to top section 460 can be used to return to the top of content included within the content section 244.

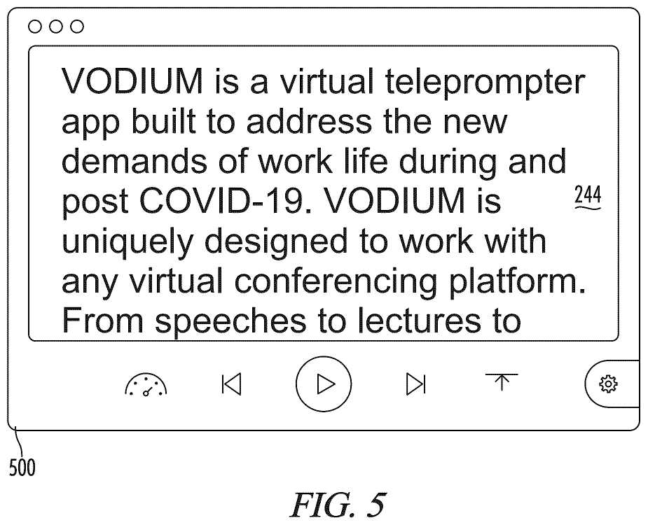

FIG. 5 illustrates an exemplary embodiment of a content window including content according to aspects of the present disclosure. The content window 500 includes text information within the content section 244. Although illustrated as plain text in FIG. 5, it should be appreciated that content which can be presented via the content section 244 can include text, graphics, audio, links to one or more external sources such as weblinks or local device links, or any other form of data or metadata of or relating to presentable or usable information. Content presentable in the content section 244 can be entered manually by a user of the content window 240, 500, can be copy/pasted by a user into the content section 244, can be obtained from a local or remote data storage, and/or can be generated in real-time. In addition, content presentable in the content section 244 can be directly imported or viewed from another third-party software application. In embodiments, the third-party software application can be software that is within the same suite of software or from the same manufacture or distributor of the application 230.

FIG. 6 illustrates an exemplary embodiment of a settings window according to aspects of the present disclosure. The content window 600 includes a settings screen 610. The settings screen 610 can include one or more sections permitting a user to selectively modify one or more settings associated with the content window 240. For example, the settings screen 610 can provide a user with the ability to activate a license for the content window 240, to specify that the content window 240 is always on top of other windows on the user device 110, to lock the content window 240 in place on the screen area 220, to adjust a font size of content within the content section 244 of the content window, and/or to adjust a transparency of at least a portion of the content window.

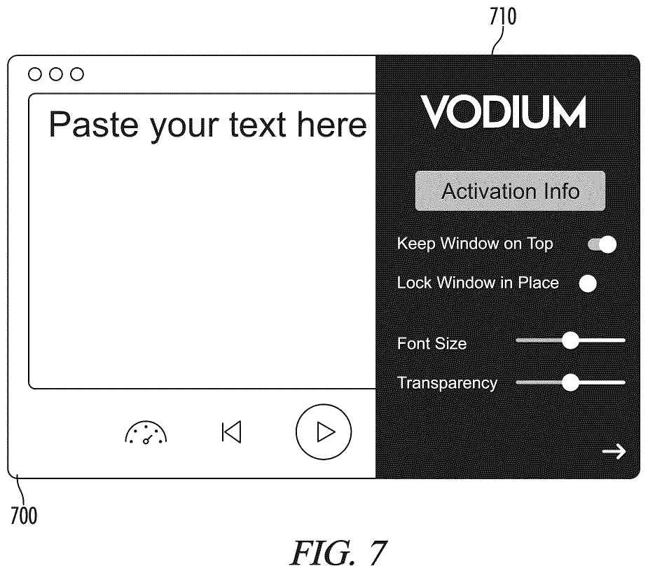

FIG. 7 illustrates an exemplary embodiment of the content window of FIG. 6 for an activated license according to aspects of the present disclosure. The content window 700 can include a settings screen 710 which reflects an activated license and can provide a user-selectable element for the user to view activation information.

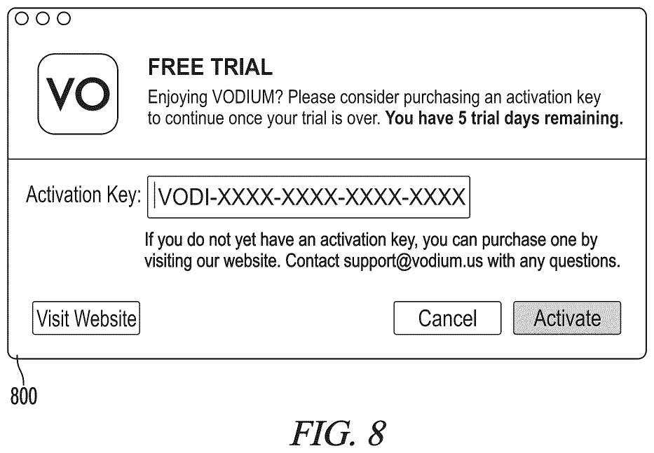

FIG. 8 illustrates an exemplary embodiment of an activation screen during a trial period according to aspects of the present disclosure. An activation window 800 can permit a user to activate a license for a content window 240. Once an activation key is provided by the user, the activation window 800 can be configured to transmit the activation key entered by the user to a verification system. If an entered activation key is accepted by the verification, one or more operations of the content window 240 can be enabled or activated.

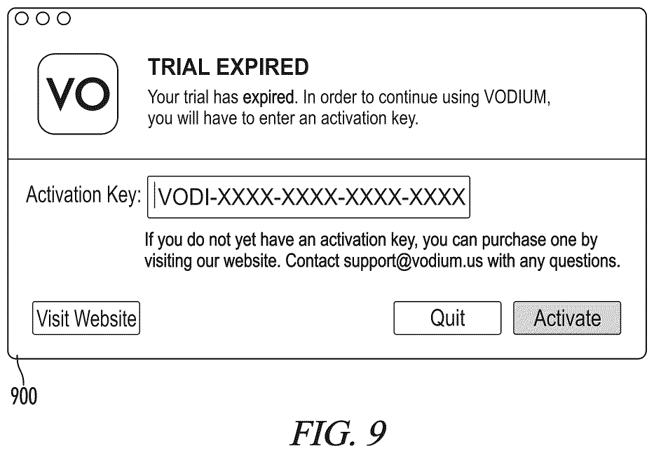

FIG. 9 illustrates an exemplary embodiment of an activation screen after expiration of a trial period according to aspects of the present disclosure. An activation window 900 can permit a user to activate a license for a content window 240. Once an activation key is provided by the user, the activation window 900 can be configured to transmit the activation key entered by the user to a verification system. If an entered activation key is accepted by the verification, one or more operations of the content window 240 can be enabled or activated.

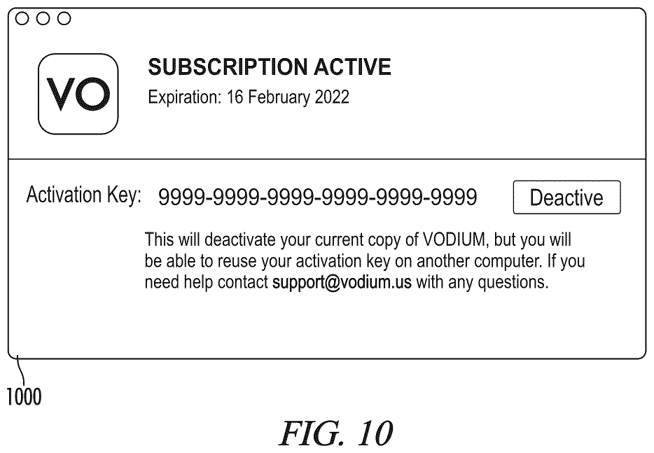

FIG. 10 illustrates an exemplary embodiment of a subscription verification window according to aspects of the present disclosure. A subscription activation window 1000 can include information relating to an active subscription, such as an expiration date, an activation key, a deactivation section to deactivate a current copy of the content window 240, or any other information or metadata relating to a subscription or status.

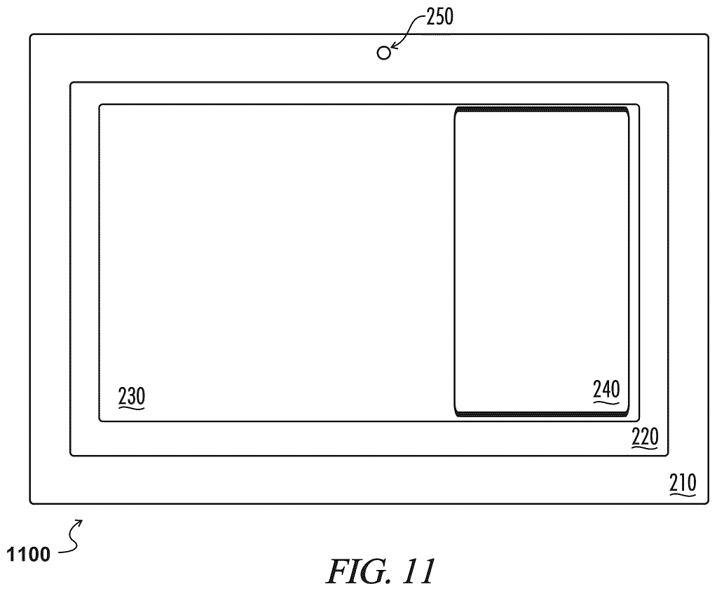

FIG. 11 illustrates an alternative partial block diagram of an on-video configuration according to aspects of the present disclosure. The system 1100 includes the display unit 210 of FIG. 2, but with the content window 240 positioned along the side or withing a “sidebar” of the application 230. Such orientation can be utilized to provide the user with ready access to the content window 240 and associated content therein. The FIG. 11 embodiment can be particularly useful in embodiments wherein the systems disclosed herein are integrated within a videoconferencing application 230.

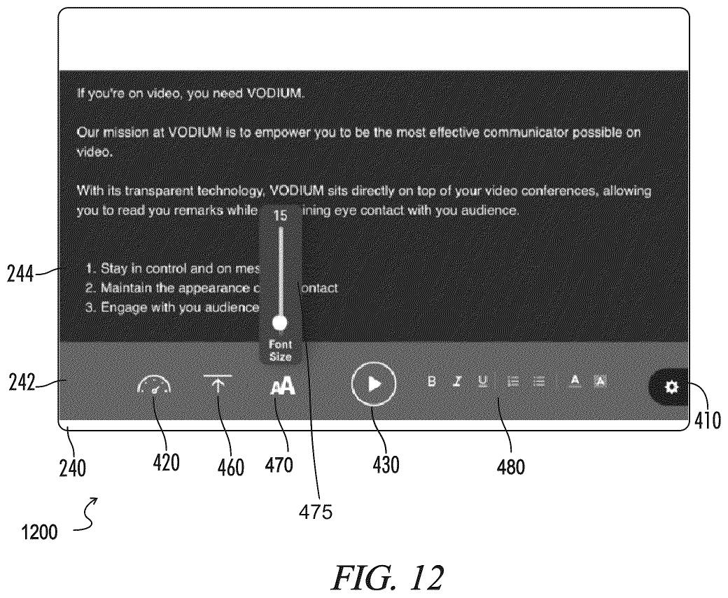

FIG. 12 illustrates an exemplary embodiment of a content window according to another aspect of the present disclosure. The content window 240 can include a body 242 and a content section 244. The body 242 can include one or more of a settings section 410, a timing section 420, a play section 430, a return to top section 460, a font section 170, or a combination thereof. The settings section 410, a timing section 420, a play section 430, a return to top section 460 can function as described above with respect to FIG. 4. The font section 470 can be selectable by a user to permit a user to selectively adjust the size of the font as displayed within the content window 240. In embodiments any of the various sections described herein can be selected by directing a cursor over the applicable section and “clicking” a mouse to interact with the setting. Alternatively, the section can be accessed by hovering a cursor over the applicable section for a given period of time such that an interaction window appears. For example, as illustrated in FIG. 12, when hovering over or clicking the font section 470 can cause the disclosed systems to generate and display a font size slider 475 or other means of setting or adjusting the font size of text within the content section 244. In addition, the body 242 can comprise a text editing section 480 which permits the user to implement rich text formatting, such as bold, italicize, highlighting, and underline text, as well as bullet and number.

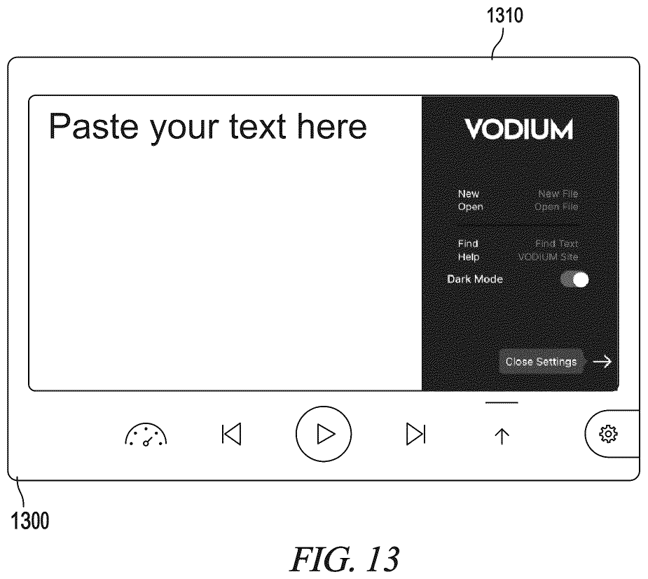

FIG. 13 illustrates an exemplary embodiment of the content window of FIG. 6 according to additional aspects of the present disclosure. The content window 1300 can include a settings screen 1310 which reflects an option to open a file, create a new file, find text within a file, direct the user to a help website, engage or disengage a dark mode, or a combination thereof.

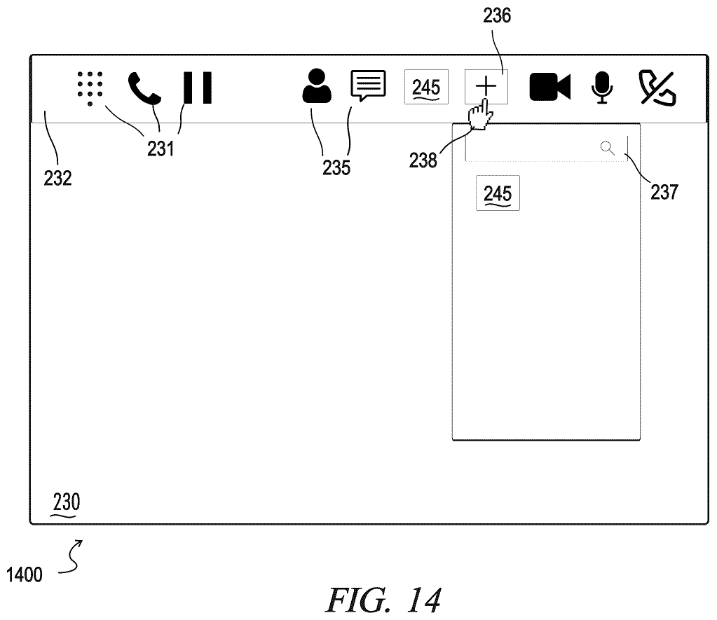

FIG. 14 shows a schematic view of a system 245 under another embodiment 1400 of the present disclosure, wherein the system 245 is configured to operate within the environment of a pre-existing application 230. As can be seen, in this embodiment, the application 230 can comprise a tablature bar 232 that comprises one or more action icons 231 (e.g., a dial pad, a call icon, a “hold” icon, a camera icon, a microphone icon, an “end call” icon, or a combination thereof). The tablature bar 232 can further comprise one or more tabs or apps 235 that can operate within or otherwise be integrated within the application 230. The presently disclosed system 245 can be seen integrated within the application 203 and accessible as an app, tab, or channel within the tablature bar 232 of the application 230. The tablature bar 232 can further comprise an app addition icon 236 for locating and adding one or more tabs, channels, or apps 235 to the tablature bar 232. Selection of the app addition icon 236 can open a search bar 237 which permits a user to search a database of apps, channels, or tabs 235 that can be added to the tablature bar 232. In embodiments, as shown in FIG. 14 the presently disclosed system 245 is within the database of apps, channels, or tabs and can be displayed to a user via the search results. When selected from the search results, the presently disclosed system 245 can be added to the tablature bar 232 for easy access within the application 230. In embodiments, after selecting the system icon 245 with the tablature bar 232, the system 245 opens via a content window 240, such as that previously described herein.

In one embodiment, the presently disclosed systems and methods are integrated within Microsoft Teams® (Microsoft Corporation, Cincinnati, OH) as an “in-tab” experience. In such an embodiment, the presently disclosed system operates within the Microsoft Teams® (Microsoft Corporation, Cincinnati, OH) environment. The system can be included within a database of apps, meeting tabs, channels, add-ins, or a combination thereof within the Microsoft Teams® (Microsoft Corporation, Cincinnati, OH) environment. In embodiments, after selection of the system icon 245, the content window 240 opens and is displayed within the Microsoft Teams® (Microsoft Corporation, Cincinnati, OH) application (see, e.g., FIG. 11). In certain embodiments, the presently disclosed systems and methods provide a means for hiding or minimizing the content window 240 within the Microsoft Teams® (Microsoft Corporation, Cincinnati, OH) environment. In embodiments, the content window 240 of the presently disclosed systems and methods can be freely moved within the Microsoft Teams® (Microsoft Corporation, Cincinnati, OH) application such that the content window 240 can be positioned within the application 230 at any location that is convenient for a user. In certain embodiments, the presently disclosed systems and methods provide a “pop-out” feature that can be used to permit movement of the content window 240 to various locations on the user's screen.

Implementations consistent with the present disclosure can include a transparent app that sits on top of video conferences allowing a user to maintain eye contact and to reference notes while presenting virtually, including but not limited to the VODIUM® app.

Though not required for operation, it can be possible to provide third party platform integrations and/or implementations consistent with the present disclosure. For example, integrations of an application or platform as disclosed herein with web conferencing providers such as Zoom, Google Meet, and/or Microsoft Teams® (Microsoft Corporation, Cincinnati, OH) meetings, or direct implementations thereby of an invention as disclosed herein, can be initiated or joined from a hosted interface by way of a user selection, such as a button (or input for joining via meeting code). Furthermore, call functionality of existing web conference providers can be provided within a hosted app within the scope of the present disclosure and using the hosted interface. One or more features described herein can be provided via one or more third parties, such as web conference providers, by implementing at least a portion of code in conjunction with a Software Development Kit (SDK) of the web conference provider software, for example by utilizing a web conference provider software to integrate with the hosted application (e.g., VODIUM). Implementations consistent with the present disclosure can include the ability to connect to a calendar, for example to include access meetings and details via a calendar connection. Social media integration can be provided alongside a calendar integration. For example, a user can be permitted to connect to a calendar and/or to obtain information from a calendar to find people in a meeting and then scrape their social media accounts and optionally display facts about them within the app.

One or more dynamic advertisements can be provided in an integration of third-party advertising and messaging materials with respect to a hosted application as disclosed herein. Automatic scrolling can be provided for a set period of time in various embodiments. For example, a user can select how long they have to speak, and the hosted app can be configured to automatically select a scroll speed to fill and hit the allotted amount of time. Text can be saved locally within the hosted app in various exemplary embodiments. Users can be provided with the ability to connect with their personal or business cloud solution(s) to access and import text from documents. Users can further be provided with the ability to access documents from a desktop. For example, by providing the ability for users to and import text from documents from their website.

Implementations consistent with the present disclosure can further provide white labeling by providing, among others: the ability for enterprise customers to integrate logo and brand colors within the hosted app; the ability for enterprise or events customers to integrate sponsor logos, colors, and text within the hosted app; the ability for platform providers to fully white label the hosted app such that the interface looks like its own platform interface; and the like.

Implementations consistent with the present disclosure can include the content window 240 being capable of both a light and a dark mode, for example as used to select and/or modify one or more color or brightness settings associated with at least a portion of the content window 240. Users can be provided with the ability to switch from dark mode to light mode and vice-versa. The app can include a timer feature which provides the ability for users to set timer that counts up to help with pacing of speeches or presentations. The app can further include a recording feature which provides the ability to record speeches within the hosted application and store recordings locally within the app. A watermark feature can provide the ability to display logo or watermark to let virtual audiences know users are using the app in certain scenarios.

Implementations consistent with the present disclosure can include a remotely controlled content window which provides the ability for one user to access and control another user's app, including uploading and editing text and controlling the scrolling and all settings (e.g., via local or internet communication(s) between the user device 110 and another user's device). One or more embodiments can include the ability to control a hosted scroll parameter (e.g., speed, location. timing) using one or more keyboard shortcuts. Content within the content window 240 can include the ability to implement rich text formatting, such as bold, italicize, and underline text, as well as bullet and number (see 480 of FIG. 12). Users can further be provided with the ability to provide pacing marks within the app to see how far text will move when using the tap to scroll buttons.

In various exemplary embodiments, the present disclosure relates to a system to permit a user to reference their notes while making virtual presentations. The disclosed system can be configured to be presented on a user's display during a virtual meeting or presentation. In embodiments, the system permits the user to insert or revise text (such as a speech or presentation notes) within a content section 244 of a content window 240 for later reference during a presentation or video conference. Such systems can permit the user to read hands free while addressing their audience during a virtual meeting or video teleconference. In various embodiments, the disclosed systems permit users to manually control an application to reference points of interest such as, but not limited to notes, questions, or key points. In embodiments, the systems permit users to: (1) prepare text within a video conferencing application platform; (2) position inserted text within a content window 240 on the user's display 210, such as below the camera of a computing system to ensure that the user maintains eye contact with the camera while referencing the inserted text during a presentation; (3) place inserted text in location that on the screen area 220 of the display (such as in a sidebar) for easy access when necessary (for example, see FIG. 11); or a combination thereof. The systems disclosed herein can be formatted for use on a mobile device, a laptop computer, a desktop computer, or a combination thereof.

In embodiments, the presently disclosed system provides an in-meeting scrolling text function that works within a videoconference application to promote engagement with a virtual audience while the user references text or notes. The presently disclosed system can include autonomous scrolling of content (such as previously inputted text), a user-directed or “manual” scrolling of content during a presentation, or a combination thereof. In embodiments, the system permits a user to select a given speed for autonomous scrolling such that a hands-free mode is activated. The speed of the autonomous scrolling can be configured to match that of the user's communication style and speed. When employing the user-directed or “manual” scrolling of text, a user can determine when to advance the viewable text for complete control over delivery. In various embodiments, the user can direct the system to switch between an autonomous or manual scrolling mode. Manual scroll mode can be activated upon the user interacting with a given portion of the content window 240 or application 230 user interface.

The system can include a file management process that interfaces with a user's existing workflow. By way of example, such a file management system can permit a user to draft text, revise text, insert text, otherwise edit text within the disclosed system. In embodiments, a user can upload text into a content section 244 of the system, paste text into the content section 244 of the system, save a text file created within the system, or a combination thereof. Such embodiments can also promote collaboration by providing a plurality of users access to the inserted or revised text such that at least one of the plurality of users can access and revise the text and save changes according to the systems and methods described herein.

Embodiments of the present system can provide fully customizable text to permit a user to emphasize certain text (see 480 of FIG. 12). This customizable text can assist a user with remembering to emphasize certain points during a presentation, keep the user on a particular message, or permit the user to have consistent text that is stylized similar to the user's preferred or existing settings. Non-liming examples of such customizable options include any one or more of the following: font size, rich text formatting, dark/light mode. text search.

In various embodiments, the presently disclosed systems and methods are compatible with videoconferencing software or applications. By way of non-limiting example, the disclosed systems can be compatible with Zoom, ConnectvVise Control, BlueJeans Meetings, Microsoft Teams® (Microsoft Corporation, Cincinnati, OH), Google Hangouts Meet, or any other audio, video, or other form of conferencing or communications-capable software or module. In embodiments, the presently disclosed system can be integrated within a videoconferencing software 230 such that the system is accessible within a user interface of the videoconferencing software 230.

The presently disclosed systems can be added to a user's video conference software (such as Microsoft Teams® (Microsoft Corporation, Cincinnati, OH)) from the “Apps section” of the software, in the in-meeting experience of the videoconference software (for, example, see FIG. 14), or via the app store of a third-party entity or the distributor of the video conferencing software, or a combination thereof.

The COVID-19 pandemic and shift to virtual work has radically changed communication. Despite remote work becoming increasingly common, there remains a lack tools for transforming the way individuals work and specifically maintain an engaging presence while presenting and communicating virtually. This puts even the most skilled communicators at a disadvantage.

Communication is predominantly nonverbal, with some studies suggesting that up to 93% of communication relies on nonverbal cues. Thus, a significant amount of communication can be lost during a virtual conference or meeting or a videoconference. Under such circumstances, even the most skilled presenters can struggle with effective communication. For example, eye contact is critical to communication-increasing trust by 16%—but it doesn't come naturally when presenting virtually.

Certain studies suggest that individuals decide whether they find a particular subject interesting or not within the first eight seconds of a presentation. However, when presenting virtually, it can be difficult to convey tone without body language. It's even harder to maintain eye contact, and it can be nearly impossible to capture your audience's attention from the outset of a virtual presentation. In various embodiments, the presently disclosed systems and methods address these challenges of communicating virtually, including the ability to juggle multiple tasks and user interface windows at once while also permitting the user to maintain the appearance of eye contact with the camera. This allows users to focus on their delivery and engaging their audiences in all professions and all settings.

In embodiments, the presently disclosed system allows a user to present confidently and stay on message on video conference meetings. For example, under one embodiment, the presently disclosed systems permit a window or pop-out feature in the user interface or content window 240 to be positioned directly beneath the user's computer's camera, ensuring that the audience feels like the user is speaking directly to them. In certain embodiments, the presently disclosed system is accessible within the “in tab” experience of a videoconferencing app 230, such as Microsoft Teams® (Microsoft Corporation, Cincinnati, OH).

The various embodiments disclosed herein permit a user to reference the user's content (e.g., input text (such as a script or meeting notes)) during a presentation. The system can permit automatic text scrolling, manual scrolling, or a combination thereof.

In certain embodiments, the system permits productive and efficient meetings. By way of example, the meeting agenda and any associated questions or topics of interest can be centered in front of the user or present for ease of reference. The disclosed systems can improve performance by the presenters such as by reducing speaking errors, increasing user confidence, and maintaining engagement with the audience. The presently disclosed system can permit a user to improve their delivery of a prepared presentation or talk such as by reducing the number of times that a user needs to divert their gaze to review notes or look at a different window or screen of the user's computing device or mobile device. The presently disclosed system can improve a user's efficiency. In embodiments, the present systems reduce a user's preparation time such as by preventing the user from having to memorize talking points. The disclosed systems can be employed during sales pitches and recruiting endeavors to increase success and reduce the need for the user to look away from the target. The present systems can be employed to improve fundraising success such as by permitting the user to take and maintain control of conversations and providing a prompt or reminder to the user to ask certain questions at certain times. In embodiments, the prompt can include a reminder for the user to propose a funding amount at a specific time during a presentation or meeting to ensure a well-timed request.

In embodiments, the presently disclosed systems provide a scrolling text (whether automatically or manual) to a user pursuant to user-defined parameters to promote engagement during virtual presentation. In embodiments, the present system is configured to be executable within a video conferencing software (see, e.g., FIGS. 11-14), accessible as a separate program, or a combination thereof.

Without being bound by theory, in certain embodiments, the presently disclosed systems employ generative artificial intelligence. By way of example, embodiments include the use of generative artificial intelligence to detect user questions and generate a proposed response for the user's review. The generative artificial intelligence can analyze facial expression to detect audience engagement and suggest prompts. In embodiments, if the audience appears disengaged, the generative artificial intelligence can, through the user interface or content window 240, display or suggest prompts or strategies to re-engage the audience. Such generative artificial intelligence can rely on the specific user's particular speaking style, word choice, cadence, or a combination thereof to generate a response, prompt, or strategy that appears natural to the user, the audience, or a combination thereof. Certain embodiments permit the user to review a response, prompt, or strategy, and either accept or reject the proposed response, prompt, or strategy. The system can permit the user to request a new response, prompt, or strategy if the user is dissatisfied with the proposed response, response, prompt, or strategy generated by the artificial intelligence. In embodiments, the generative artificial intelligence can record and review data from a user's prior presentations and utilize such information to assist a user in the preparation of future presentations.

In certain embodiments, the presently disclosed system can be configured to integrate with a word processing software. Without being bound by theory, such integration would allow a user to capture text from the word processing file or software and display it within the presently disclosed system. In addition, the presently disclosed systems can be integrated with a presentation software (such as Microsoft PowerPoint). Under such embodiments, the presently disclosed system prevents a user to seamlessly export information to the disclosed system while avoiding the need to “copy and paste” information or data from one application to another. The presently disclosed system can be further configured to permit a user to access or export such presentations in a pre-formatted manner (i.e., Slide 1 Notes, Slide 2 Notes).

In certain embodiments, the presently disclosed system can be integrated into or compatible with an email application (such as Microsoft Outlook). In embodiments, the system can be configured to provide a message to a user while engaging with the email application. The message can direct the user to any one or more of the applications with a given suite of applications.

In various embodiments, the presently disclosed systems permit a plurality of users to draft, share, collaborate, edit, revise, or otherwise interact with a single prepared presentation, document, or text input. Such embodiment permit a team of users to prepare a single presentation without the need to email or transfer the document between individual members of the team.

The presently disclosed system can be configured to permit users to fact check certain text (such as a speech script) prior to or during a meeting. In embodiment, the present system permits the capturing and organization of meeting notes, action items and tasks during a meeting. The systems can be configured to track and report back questions submitted through a chat function during a meeting.

The systems and methods disclosed herein can permit users to generate and manage textual inputs and scripts. By way of example, the disclosed systems can permit one or more users to outline and draft scripts, edit scripts, edit the timing and pacing of scripts, or a combination thereof. In one embodiment, the user can input a prompt into an artificial intelligence user interface to automatically adjust a script cadence such as to fit a certain timeline. For example, the disclosed systems can permit the automatic condensation of a script into a reduced timeline, such as by instructing an artificial intelligence to modify the script to fill a preferred time period.

Certain embodiments can permit one or more users, an audience member, or both to provide or receive feedback on a presentation. Exemplary feedback parameters include, but are not limited to: the use or frequency of “filler words,” the user's tone or confidence, the speed or pace of the presentation, the overall performance, how closely the user followed the script, eye contact with the cameras. In embodiments, the present systems provide audience analysis to users, including but not limited to: engagement and attention during a presentation (such as via tracking eye contact), questions asked verbally, questions asked via a chat function, polls submitted, time spent in the meeting, or any combination thereof. In certain embodiments, the systems can provide a user with an overall performance score. The overall performance score can be automatically generated by a generative artificial intelligence such as through an amalgamation of a plurality of audience sentiment metrics.

In embodiments, the systems and methods disclosed herein can be communicatively coupled with computer networks, computing devices, mobile devices, or combinations thereof. Under certain embodiments, the systems and methods disclosed herein can utilize the communicative coupling to relay data from each subsystem to other subsystems or aggregate the data into a central repository of such information.

In embodiments, the systems and methods disclosed herein can present collected data directly to a user through a display that is associated with one or more computing devices or mobile devices. The computing devices or mobile devices can be communicatively coupled to one or more applications running on at least one processor of a remote server. The systems and methods disclosed herein can transmit data or results of data analysis (as described below) to the remote server. Third party clients such as remote users receive application data through requests to remote server applications. In embodiments, such remote users can the access, draft, insert, edit, or revise any content within the content window.

As indicated above, data can be communicated to a computing application which can then be presented to a user, an audience, or a combination thereof. The computing application can initially analyze and interpret raw data to determine the user's speaking style, cadence, word choice, error rate, questions presented during or after a presentation, audience engagement, and other information. The presently disclosed system can then generate suggestions and display the same to the user during or after the presentation for the user. The presently disclosed systems and application can send analytical results to remote server applications for third party access. Under an embodiment, data analytics can be performed by the application, remote server applications, or a combination thereof.

The communicative coupling can be accomplished through one or more wireless communications protocols. The communicative coupling can comprise a wireless local area network (WLAN). A WLAN connection can implement WiFi™ communications protocols. Alternatively, the communicative coupling comprises a wireless personal area network WPAN. A WPAN connection can implement Bluetooth™ communications protocols.

Embodiments can comprise a data port for relaying data to the mobile device or other computing device. The data port can be a USB connection or any other type of data port. The data port allows for a wired communication between any one or more of the subsystems described herein and separate computing devices. The data port can be used alone or in combination with the wireless communications protocols of the subsystems described above.

Data can be reported to users via a dashboard type view for the user to see results and receive recommendations. These results are under an embodiment viewable through an application user interface or content window 240. As indicated above, data and data analysis can additionally reside on a remote server. A user can access such data and analysis through a desktop client.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network can be any microprocessor-controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network can include one of more LANs, WANs, Internets, and computers. The computers can serve as servers, clients, or a combination thereof.

The systems and methods disclosed herein can be a component of a single system, multiple systems, and/or geographically separate systems. The presently disclosed systems and methods can also be a subcomponent or subsystem of a single system, multiple systems, and/or geographically separate systems. The components of systems and methods disclosed herein can be coupled to one or more other components (not shown) of a host system or a system coupled to the host system.

One or more components of the systems and methods described herein and/or a corresponding interface, system, or application to which the systems and methods described herein are coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, a network server, or a combination thereof. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor. The term “processor” as generally used herein refers to any logic processing unit, such as one or more central processing units (CPUs), digital signal processors (DSPs), application-specific integrated circuits (ASIC), etc. The processor can be disposed within or upon a single chip. The processing system can further include at least one memory device or subsystem. The processing system can also include or be coupled to at least one database. The processor and memory can be monolithically integrated onto a single chip, distributed among a number of chips or components, and/or provided by some combination of algorithms. The systems and methods described herein can be implemented in one or more of software algorithm(s), programs, firmware, hardware, components, circuitry, in any combination.

The components of any system that include the systems and methods described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), wireless personal area networks (WPANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein can be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods described herein include: microcontrollers with memory (such as electronically erasable programmable read only memory (EEPROM)) or without memory, embedded microprocessors, firmware, software, etc. Furthermore, aspects of the systems and methods described herein can be embodied in microprocessors having software-based circuit emulation, discrete logic (sequential and combinatorial), custom devices, fuzzy (neural) logic, quantum devices, and hybrids of any of the above device types. Of course, the underlying device technologies can be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein can be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions can be embodied include, but are not limited to, non-volatile storage media in various forms (e.g., optical, magnetic or semiconductor storage media) and carrier waves that can be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above-described components can be processed by a processing entity (e.g., one or more processors) within the computer system in conjunction with execution of one or more other computer programs.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed:

1. A method for providing on-video content during a video presentation by at least one user, the method comprising, during execution of one or more applications by an electronic device associated with at least a display unit and a capture element having a field of view including the at least one user:
generating in a screen area of the display unit a first image layer comprising content associated with at least one of the one or more applications;
generating in the screen area of the display unit a second image layer comprising a content window,
wherein content displayed in the content window is provided in accordance with the at least one of the one or more applications, and
wherein a generated location of the content window within the screen area can be arranged at a user-preferred position, the user-preferred position being:
dependent at least in part on a determined location of the capture element;
disposed within a side window of the one or more applications, such that the content window is accessible within an environment of the one or more applications;
at least partially overlapping the first image layer; or
a combination thereof.

2. The method of claim 1, further comprising automatically revising the content according to a user-preferred parameter, wherein the user-preferred parameter comprises a time limit for the video presentation.

3. The method of claim 2, wherein automatically revising the content comprises any one or more of: automatically adding additional content to satisfy the time limit, automatically increasing a scrolling speed of the content on the display unit to satisfy the time limit, removing content to satisfy the time limit, decreasing the scrolling speed of the content to satisfy the time limit, or a combination thereof.

4. The method of claim 1, further comprising automatically ascertaining a location of the at least one user relative to the capture element.

5. The method of claim 1, further comprising automatically detecting a performance metric of the user via the capture element, analyzing the performance metric of the user, and automatically providing feedback to the user.

6. The method of claim 5, wherein the performance metric comprises any one or more of a use or frequency of filler words, the user's tone or confidence, a speed or pace of the presentation, the user's adherence to the content, and an amount of user eye contact with the capture element.

7. The method of claim 1, further comprising providing an audience member with one or more applications for viewing the video presentation on an audience member electronic device that is associated with a second display unit;
generating in a screen area of the second display unit a content-viewing window; wherein the video presentation is provided in the content-viewing window in accordance with the at least one of the one or more applications;
generating and displaying a feedback input portion of the content-viewing window;
accepting a feedback input from the audience member;
automatically transmitting the feedback input to the electronic device; and
displaying the feedback input to the user via the content window.

8. The method of claim 7, further comprising an audience member capture element having a field of view including the audience member;
capturing an audience sentiment metric from the audience member via the capture element;
automatically analyzing the audience sentiment metric;
automatically generating a performance score, wherein the performance score is dependent on the audience sentiment metric; and
displaying the performance score to the user via the content window.

9. The method of claim 8, wherein the audience sentiment metric comprises the amount of time the audience member's eyes are directed toward the content-viewing window, a number of questions asked verbally by the audience member, a number of questions asked in a chat feature of the one or more applications, a time the audience member spends in front of the capture element, a number of times the audience member looks away from the content-viewing window, the total amount of time the audience member spends looking away from the content-viewing window during the video presentation, audience participation in polls, audience time spent speaking as compared to the speaker time spent speaking, or a combination thereof.

10. The method of claim 1, wherein the content is displayed in the content window according to one or more parameters set via user input from the at least one user.

11. A system for providing on-video content during a video presentation by at least one user, the system comprising:
an electronic device comprising a processor functionally linked to at least a display unit and a capture element having a field of view including the at least one user,
wherein the processor is configured, during execution of one or more applications via the electronic device, to:
generate in a screen area of the display unit a first image layer comprising content associated with at least one of the one or more applications;
generate in the screen area of the display unit a second image layer comprising a content window; and
wherein a generated location of the content window within the screen area is arranged at a user-preferred position, the user-preferred position being:
dependent at least in part on a determined location of the capture element;
disposed within a side window of the one or more applications, such that the content window is accessible within an environment of the one or more applications;
at least partially overlapping the first image layer; or
a combination thereof.

12. The system of claim 11, wherein the at least one of the one or more applications comprises a web conferencing platform.

13. The system of claim 11, the processor being further configured to automatically revise the content according to a user-preferred parameter, wherein the user-preferred parameter comprises a time limit for the video presentation.

14. The system of claim 13, wherein automatically revising the content comprises any one or more of: automatically adding additional content to satisfy the time limit, automatically increasing a scrolling speed of the content on the display unit to satisfy the time limit, removing content to satisfy the time limit, decreasing the scrolling speed of the content to satisfy the time limit, or a combination thereof.

15. The system of claim 11, the processor being further configured to automatically ascertain a location of the at least one user relative to the capture element.

16. The system of claim 11, the processor being further configured to automatically detect a performance metric of the user via the capture element, analyzing the performance metric of the user, and automatically providing feedback to the user.

17. The system of claim 16, wherein the performance metric comprises any one or more of a use or frequency of filler words, the user's tone or confidence, a speed or pace of the presentation, the user's adherence to the content, and an amount of user eye contact with the capture element.

18. The system of claim 11, further comprising
an audience member electronic device comprising a second processor functionally linked to a second display unit and a second capture element having a field of view including at least one audience member, wherein the second processor is configured, during execution of one or more applications via the audience member electronic device, to
generate in a screen area of the second display unit a content-viewing window associated with at least one of the one or more applications, the content-viewing window being configured to display the video presentation to the at least one audience member;
generate and display a feedback input portion of the content-viewing window;
accept a feedback input from the at least one audience member;
automatically transmit the feedback input to the electronic device; and
wherein the processor on the electronic device is configured to display the feedback input to the user via the content window.

19. The system of claim 18, further comprising an audience member capture element having a field of view including the audience member;
the audience member capture element configured to capture an audience sentiment metric from the audience member;
the second processor configured to transmit the audience sentiment metric to the electronic device;
the processor being configured to
receive the audience sentiment metric;
analyze the audience sentiment metric;
generate a performance score, wherein the performance score is dependent on the audience sentiment metric; and
display the performance score to the user via the content window.

20. The system of claim 19, wherein the audience sentiment metric comprises the amount of time the audience member's eyes are directed toward the content-viewing window, a number of questions asked verbally by the audience member, a number of questions asked in a chat feature of the one or more applications, a time the audience member spends in front of the capture element, a number of times the audience member looks away from the content-viewing window, the total amount of time the audience member spends looking away from the content-viewing window during the video presentation, or a combination thereof.
